(19) United States
(12) Patent Application Publication
(10) Pub. No.: US 2019/0156365 A1
(43) Pub. Date: May 23, 2019

(54) SESSION CONTROL METHOD

(71) Applicant: Andre Schussel, Sao Paulo (BR)

(72) Inventor: Andre Schussel, Sao Paulo (BR)

(21) Appl. No.: 16/224,547

(22) Filed: Dec. 18, 2018

Related U.S. Application Data
(62) Division of application No. 14/017,002, filed on Sep. 3, 2013.
(60) Provisional application No. 61/696,979, filed on Sep. 5, 2012.

(51) Int. Cl. G06Q 30/02

(52) U.S. Cl. CPC G06Q 30/0251; G06Q 30/0272; G06Q 30/0277

(57) ABSTRACT

A session control method involves connecting one user device to a machine, monitoring a connection between a second user device and the machine, correlating an advertisement to the first user device based on a first connection, disconnecting the first user device from the machine for an interval and presenting the advertisement on the first user device, disconnecting the second user device from the at least one machine during the interval, and reconnecting the first user device to the at least one machine via the gateway after the interval.

### CROSS REFERENCE TO RELATED APPLICATIONS

This application is a divisional of U.S. patent application Ser. No. 14/017,002, filed on Sep. 3, 2013, which claims the benefit of priority of U.S. Provisional Patent Application Ser. No. 61/696,979, filed on Sep. 4, 2012, and incorporates by reference the disclosures of each of the aforementioned applications by reference in their entirety into the disclosure of this application.

### TECHNICAL FIELD OF THE INVENTION

The present invention relates to mobile advertising software, applications, systems, and methods of controlling access to internet services on PC systems, mobile phones, and tablets.

### BACKGROUND

Conventional internet service providers require users to pay a fee for access to wired or wireless internet.

Users who do not have data access, cannot afford data access, or wish to use a different type of data access than currently used are limited in their options to engage in internet usage outside of conventional internet services such as, for example, paying a fee for a different internet service provider.

For internet users who are mobile, roaming charges may deter alternative data plan purchases and prepaid data plans may be insufficient to allow a user to access an alternative plan while roaming.

Desktops and portables computers running any operating system (OS) like Windows, MacOS, or Linux and mobile devices (cellular phones and tablets) running any OS like iOS, Android, or Windows Phone are defined as user terminals. End users are defined as any people using its terminal.

Application is the term used to define the software invention that provides the mechanism of controlling the IP communication.

Authorization code is a code provided by the service provider and is required to prevent fraud and network control. This code is obtained via short message service (SMS) registration or portal registration.

A mobile IP channel is a mobile operator service such as, for example, GSM, WCDMA, 2G, 3G and 4G Radio Frequency data transmission sources.

The term PDP shall mean Packet Data Protocol.

The term PDN shall mean Packet Data Network.

The term MSISDN shall mean a Mobile Subscriber Integrated Services Digital Network Number.

The term IMSI shall mean an International Mobile Subscriber Identity.

The term SSID shall mean a Service Set Identifier, such as, for example, the name of a WiFi network.

A SIM card may be a subscriber identity module or subscriber identification module (SIM) is an integrated circuit that securely stores the International Mobile Subscriber Identity (IMSI).

The term HLR shall mean Home Location Register.

The term HSS shall mean Home Subscriber Server.

LTE has been designed to support packet services in a more efficient manor than 3G. The key service, from a wireless data network perspective, is the establishment of the data session that will be used by the mobile device for data services. In 2G/2.5G and 3G, the key to establishing a data session is the Packet Data Protocol (PDP) Context establishment procedure. In LTE, the procedure has been changed to an Evolved Packet System (EPS) Bearer Setup.

When a Primary PDP Context is established, this allocates an IP address to the mobile device. Like described before, the application will manage the PDP context for its own purposes and use of special parameters values.

If the solution is operating under an LTE network, instead of managing the PDP context it may manage the Default EPS Bearer and Dedicated EPS Bearer under the packet date network connection (PDN Connection).

### SUMMARY OF THE INVENTION

Systems and software for personal computers (PC), such as desktops and portable computers, and mobile devices (MD), such as cellular phones and tablets, may focus on controlling IP communication channels that will provide end user IP data access for free or sponsored in exchange for advertisements, solicitations, or other third party access to the mobile device or personal computer.

An exemplary method and system includes a client-software for PCs and MDs, an advertisement server (AdS), which may send one or more new advertisements to the user, and a Fraud Prevention Server (FPS). Additionally, an exemplary method and system may require a registration portal depending on each service provider (SP).

An exemplary AdS advertisement may be similar to a television commercial or cinema intermission in that the terminal IP communications are temporarily stopped, one or more advertisements or other third party content are communicated to the terminal or web browser screen, and allow user(s) to resume data activity upon conclusion of the advertisement or third party content.

In one example, an AdS advertisement may be in the form of a banner, a full-screen image or video covering a web-page or terminal screen, or a partially covered web-page or terminal screen of the user. According to one aspect of an exemplary system and method, an advertiser may select the characteristics of the AdS advertisement.

### BRIEF DESCRIPTION OF THE DRAWINGS

FIG. 1 shows a diagrammatic view of an ad-based internet system.

FIG. 2 shows an exemplary mobile terminal main screen.

FIG. 3 shows an exemplary service provider selection screen.

FIG. 4 shows an exemplary registration portal screen.

FIG. 5 shows an exemplary AdS administrative graphical user interface.

FIG. 6 shows another exemplary AdS administrative graphical user interface.

FIG. 7 shows an exemplary user-control administrative graphical user interface.

FIG. 8 shows another exemplary user-control administrative graphical user interface.

FIG. 9 shows an exemplary application browser screen.

FIG. 10 shows an exemplary user-preference selection portal.

FIG. 11 shows an exemplary method of services.

In the drawings like characters of reference indicate corresponding parts in the different figures.

### DETAILED DESCRIPTION

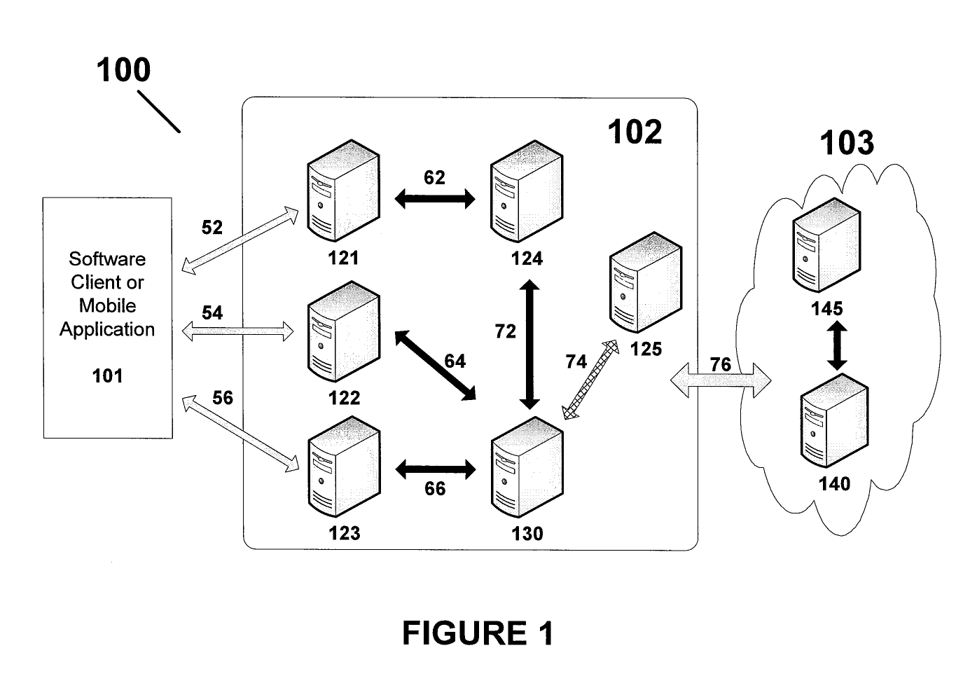

With reference to FIG. 1, an exemplary general architecture of an ad-based internet service system 100 may include a client device 101 (which may also be referred to as one or a plurality of machines such as a PC or MD), a service provider network 102, and an internet cloud 103. An exemplary client device 101 may be embodied by a cellular telephone, lap top, smart phone (such as, for example, Android or iPhone), tablet PC, or desktop computer. The client device 101 may contain one or more processors and attendant circuitry known to those in the art which enable the device 101 to execute software to run one or more applications consistent with the teachings and description provided herein. For example, a smart phone may contain a processor configured to run a mobile application that works in conjunction with an internet service provider to provide data communication between one or more websites and the user's phone.

An exemplary service provider network 102 may include one or more Serving GPRS Support Nodes (SGSN) 121 such as, for example, Cisco SGSN Serving GPRS Support Nodes sold by Cisco Systems, Inc. of San Jose, Calif. Other SGSN or SGW of Alcalu and Ericsson are also suitable alternatives. An SGSN 121 may provide internet communication via 2G, 2.5G or 3G communication channels 52 to one or more 2G, 2.5G, and/or 3G compatible client devices 101. The service provider network 102 may alternatively include one or more signaling gateways (S-GW), such as, for example an SGW Serving Gateway sold by Cisco Systems, Inc. of San Jose, Calif. An SGW 122 may provide internet communication via LTE or 4G communication channels 54 to one or more LTE or 4G compatible client devices 101. In another exemplary network 102, a WiFi portal. Similar to an SGW 122, a WiFi portal 123 may provide internet communication via LTE or 4G communication channels 56 to one or more LTE or 4G compatible client devices 101. These various servers 121, 122, and 123 may communicate with one or more user devices 101 via one or more of the possible communication channels 52, 54, or 56 depending on the user's device compatibility, terms of service, and service provided by the system 100 to the user.

Depending on the hardware used to communicate with a user device 101, one or more of the servers 121, 122, and 123 may coordinate data transfer between the user and the network in certain ways. For example, for an exemplary SGSN 121, a direct communication channel 62, such as an Ethernet or wireless connection, is provided between the SGSN 121 and a Gateway GPRS Support Node (GGSN) 124. An exemplary GGSN 124 may include the Cisco Gateway GPRS Support Node sold by Cisco Systems, Inc. of San Jose, Calif. Ultimately, an exemplary SGSN 121 may communicate via channel 72 to a user-control server 130. In another exemplary embodiment, an S-GW 122 or WiFi portal 123 may communicate with the user-control server 130 by channels 64 and 66 respectively.

According to an exemplary embodiment of the present invention, user-control server (UCS) 130 may act as a proxy server within the service provider network 102. According to an exemplary embodiment, a UCS 130 may monitor the behavior of the user device 101 and control content provision to the user device 101 from internet gateway 125. The channel of communication 74 between gateway 125 and UCS 130 may be hardwire or wireless, but preferably a landline connection with sufficient service bandwidth and data delivery capabilities. Usually, the internet gateway belongs to one or more service providers.

In a preferred embodiment, UCS 130 may be a fraud prevention server (FPS). The FPS Server 130 may act as a session control for each user device 101 using internet services from service provider network 102. In an exemplary service method, once a user device 101 sends communications via one or more servers 121-124 and channels 52, 54, 56, 62, 64, 66 and 72 to FPS 130, the FPS may redirect the user device 101 so as to allow internet connectivity between gateway 125 and user device 101. As described in this exemplary method, FPS 130 may serve as security of service network 102 as well as maintain integrity of internet connections from gateway 125 throughout the user device 101 use of the system 100.

As far as inspection of IP packets for knowing user MSISDN, UCS/FPS Server 130 may also look for user device information like OS type and language, web browser/device/connection type and other possible info available to request the most suitable advertisement for the user. Moreover, UCS/FPS Server 130 may keep a record locally of how many connections per day or how many connections per MSISDN.

According to one aspect of an exemplary advertisement-based service method and system, a user device 101 may require an operator SIM card registration and network signal if SIM card is available. Upon registration, a user device 101 may be configured to launch an application to connect a user device 101 to gateway 125 via a network having a UCS 130 and AdS 140/145. A user may be given the option to select a type of network connection, such as GSM or DMA mobile IP channels from a mobile operator or WiFi from a mobile operator or hotspot WiFi provider.

In one embodiment, an unrecognized user device 101 may need to register with the ad-based internet service system. In one embodiment, an exemplary registration may involve the system's delivery of an SMS or text message to a mobile user device 101. Alternatively, an exemplary registration process may involve redirecting the browsing screen of a user device 101 to a registration portal. In either of the aforementioned exemplary scenarios, the user device 101 may receive an authorization code via SMS or portal screen. In a preferred embodiment in which a WiFi connection is used, a redirected portal would be most likely to be means for registration of a user device 101. In another preferred embodiment, a user authorization code together with device 101 mobile phone number (MSISDN) are stored at service provider HLR/HSS and checked in order to guarantee security aspects. In a preferred embodiment, one authorization code should be generated for each mobile phone number (MSISDN) a user has.

In an exemplary embodiment in which users have an active SIM Card, users with active SIM Card may already be authenticated by mobile operators using SIM card network standard authentication. In an exemplary embodiment of the described system and method, the system may maintain 3GPP and LTE security aspects, such as IP spoofing prevention using the SIM card standard authentication. With the service authorization code generated when registration is done, it provides extra security to avoid fraud, as a mobile operator network could prior to enable data channel checks (normally at HLR/VLR database) if the code matches the one previously generated to the user (identified by IMSI/MSISDN) when SMS requesting service was sent or code generated at a web portal.

In yet another exemplary embodiment, a WiFi portal authentication may be located at some point within the service provider network 102 or, alternatively, may be hidden/embedded in the user device browser or software. A “hidden” portal may be used to block users who attempt to reach the WiFi portal without the application, resulting in a blocked message being sent to the user device screen or display of an empty page.

This portal serves as the login input from application to service provider generate/control the user IP default gateway access/IP addresses and apply any QoS needed. Additionally an exemplary system and method may set a “keep-alive” control between an exemplary portal and mobile terminal as another source of security and quality of service control. According to this exemplary embodiment of the system and method described, such a portal may serve as an authentication portal which may control connections to one or more users whose IP address(es) have been authenticated.

In another exemplary embodiment of the system and method described, a user may fill out an information request screen. In one aspect of the exemplary method, the information provided by the user may be used by service providers to target specific advertisements at the user during a session when the user is logged into the service provider network 102.

Alternatively, information gathered from users may provide future sessions with the service provider network 102 to properly authenticate and register the user on a particular user device 101. For advertisement providers, report and control features may be beneficial for targeted advertisements as well as particular internet service sponsorship. In an exemplary embodiment, an AdS 140 may have a username and password for each advertiser/sponsor and will record relevant usage info, only authorized information from one or more user(s), and will manage a database.

An exemplary FPS Server may be a redundant server and will be able to handle a huge amount of data and will talk to GGSN/S-GW using radius, diameter or any other protocol if needed. It may be the case that the FPS Server should do a look-up at HSS server database in order to retrieve end user MSISDN data. Each participating service provider may have an FPS Server 130 in the sponsored internet services deployment. In one or more exemplary systems and methods, an FPS 130 may be optional without detriment to the control and operation of the system or method.

Coupled via channel 76 to the service provider network 102 may be an advertisement service cloud 103 including one or more AdS 140 and connected advertisement databases 145. An exemplary AdS 140 may be any commercially available server configured for multiple user applications and can accommodate an “n” client-server mode. An exemplary AdS 140 may control and register all advertisements demanded from “n” clients applications (stored on one or more user device 101), and send to these application clients advertisements from an internal advertisement database/external database 145. An exemplary external advertisement database 145 may include, for example, Grey strips, Mojiva, Google, or Facebook.

In an exemplary operation of the system and method, a PC or MD 101 may be provided IP data access for free or sponsored in exchange of receiving advertisements from one or more AdS 140 and AdS databases 145. To control the advertisements communicated to the user device 101, a client software for PCs and MDs may work with user-control terminal 130 and one or more AdS 140 to send advertisements to the view screen of the mobile device 101.

In the exemplary operation of the system and method described herein, advertisements may be communicated to user device 101 and in doing so, may temporarily stop terminal IP communications between user device 101 and gateway 125. At that time, an exemplary advertisement may occupy one or more portions of the user terminal 101 or user's web browser screen. Advertisements may be stored on AdS database 145. After a predetermined time of interaction with the advertisement, the user device 101 may resume communications with gateway 125. An exemplary advertisement may be one of a pop-up, a banner, a flash video, a transparent frame, an audio message, a download, or a combination of activities depending on what the advertiser wants. In a preferred embodiment, when an application determines after “x” seconds/minutes that it is time to send an advertisement to the user device 101, the screen of the user device 101 may display the advertisement according to advertisement display instructions stored on one or more of the UCS/FPS 130 and/or AdS 140/145. An exemplary interval between advertisements to be displayed depends on the service provider, internet connection type, speed, user information, user search desires, data usage history, time of access to the particular network, or queue of users seeking to access the network via the desired connection.

In another alternative embodiment of an exemplary system and method, a user device 101 may store one or more advertisements or control data (such as cookies or temporary internet files) that may be read by UCS 130 or AdS 140 as requiring viewing before a session of internet provision begins. Alternatively, such control data may act as session control of the user's session. For example, if a user departs from a session prior to receiving a scheduled advertisement, control data, such as a cookie, may be stored on the user's device detailing that on the next session an advertisement is due to be shown to the user. In another variant of this example, the cookie may signal the provision of an advertisement belonging to the sponsor or service provider of the previous session. However, it may be possible that the cookie signal the provision of an advertisement of the present service provider or sponsor first and remain stored in case the user tries to subsequently re-access the internet using a service sponsored or provided by the previous sponsor or internet service provider.

In yet another variant of the above example, an advertisement may be schedule to appear at the beginning of every users' session regardless of which internet provider or sponsored internet they choose to use through the exemplary system and method. As previously described, control data or session control of the type that guides provision of advertisements to a user device 101 may be governed by UCS/FPS 130.

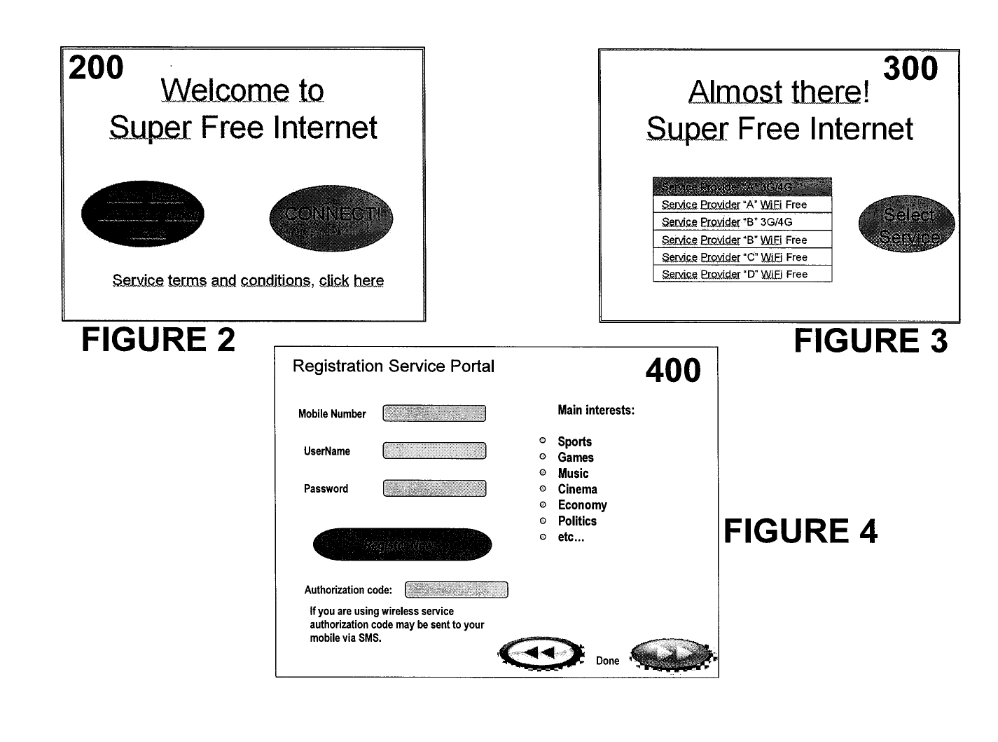

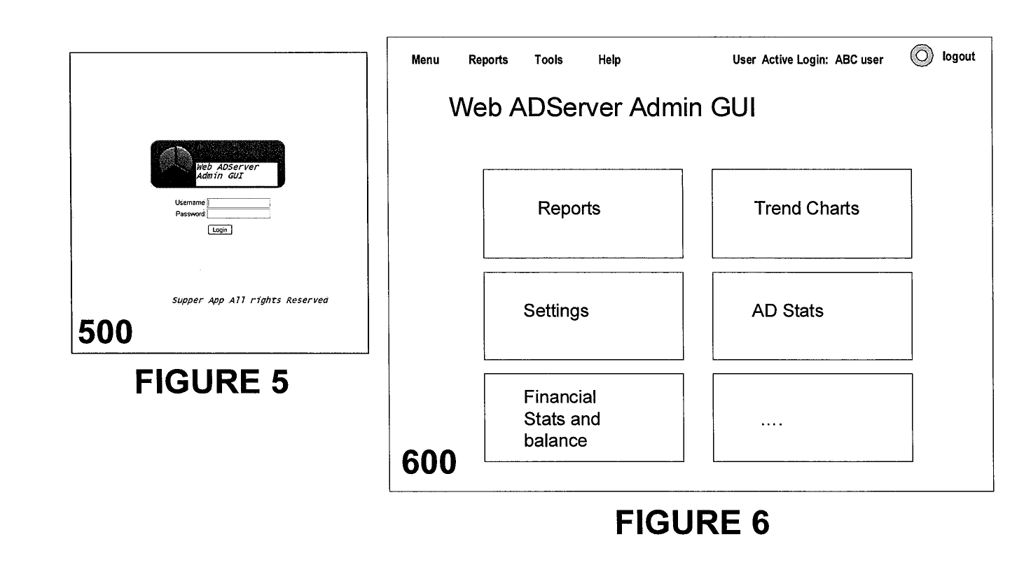

Keeping in mind an exemplary system architecture of FIG. 1, reference to FIG. 2 further details a method of use of the aforementioned exemplary system. Main screen 200 may show on user device 101 to allow users to proceed to get access to service provider network 102. In the exemplary illustration of a main screen 200, a user may register their mobile device 101 or themselves personally. Alternatively, a user may connect to the network 102. In either example, a user may be asked to agree to certain system use conditions.

FIG. 3 illustrates an exemplary channel selection screen 300. According to an exemplary embodiment of the system and method described, a user device 101 may establish one or more connections to network 102, such as, for example, connections 52, 54, and/or 56, after a user selects the type of mobile IP channel. While only exemplary, a user's channel selection screen may be determined based on the status of the user's device 101, the user's registration information, the type of potential advertising available to target the user, the sponsor of the user's internet access, or similar combinations.

In an exemplary embodiment, mobile terminals prior to connection to the internet may need to receive an IP address, such as via a PDP protocol. When the application is about to connect a user to the internet 125 it may detect if a PDP context is already established or not and if a PDP context is inactive or active. Once a current status of the terminal PDP context is detected, the application may do one or more of the following: (i) if a PDP context is established and active—the application will cancel current PDP context, and initiate a new one or just update the PDP currently used; (ii) if a PDP context is not established—the application will initiate a new PDP context; and/or (iii) if a PDP context is inactive—the application will cancel current PDP context, and initiate a new one or just re-activate and update the currently inactive PDP. While PDP context is described, alternative connections may also be established as well. For example, when connecting under an LTE/4G scenario, the exemplary system and method may manage the Default EPS Bearer and eventually Dedicated EPS Bearer (if a specific QoS information must be sent).

A PDP context managed by an exemplary system and method described may have standard parameters such as IMSI, MSISDN and may possess unique parameters such as user name, Quota=0, authorization code, and any other additional context agreed with each service provider. In a preferred embodiment, these parameter values may be sent embedded in another PDP context standard parameter previously agreed with the service provider.

In yet another preferred embodiment, embedded parameters may be sent to the SGSN/GGSN (3G and previous networks) and S-GW (LTE/4G) so the service provider network may control during the period that the PDP context is active. During an exemplary use of the system and method, parameter quota=0 may be communicated from the user device 101 and thereby indicate that no data traffic will be charged to the user.

Turning to FIG. 4, an exemplary registration service portal 400 may be shown on the screen of a user device 101. A service portal 400 may vary from service provider to service provider. At the point in the method where a user device 101 may be registered several exemplary scenarios may take place. First, a user may have an active SIM Card (with or without data plan active) or may already be connected to a different WiFi service so the application will redirect user to a registration Service Provider portal 400. Where a user may not have a data plan, the service provider will by default redirect to an exemplary registration portal 400. Second, where a user may have no active SIM Card but is already connected to a different WiFi service, an exemplary ad-based service application may redirect a user to a registration Service Provider portal 400. Third, a user may have no active SIM Card and may not be connected to any WiFi service. In this exemplary scenario, a user may agree with the service provider to permit limited access only to the registration portal 400. When a service provider does not allow such a connection, a user may have to connect to the registration portal using a PC or any terminal with internet access.

An exemplary registration portal 400 may be very simple. Preferably, a registration portal may ask basic info like mobile number, username/password, name and any other relevant information. In one preferred aspect, some info should be mandatory to be filled, like mobile number and, in situations where a user has an active SIM card, a mobile number must match. Accordingly, a successful registration may allow a portal to display the authorization code for user device 101 access to service provider network 102 In an exemplary embodiment, a mobile service provider may offer user-registration via SMS, voicemail or other ways to render an exemplary registration page 400 as a non-interactive page. In an exemplary registration step, a service provider may opt to offer user registration via SMS, in which the user may send an SMS to a specific code and then receive a SMS response with an authorization code.

According to another aspect of an exemplary system and method, a WiFi service may be offered (defined with a fixed SSID name at Service Provider level) free of charge, but may always generate a CDR from a service provider aspect to control the timing, direction, target, and amount of data transmitted.

In this exemplary embodiment, WiFi usage mode may not necessarily need to have a SIM card, but only a WiFi feature enabled at the terminal. In a preferred embodiment, a WiFi usage mode may only be operation if there had been a previous service registration. In another preferred embodiment, a WiFi usage mode may involve prior application launch and performance of standard SIM card network authentications such as EAP. In an exemplary aspect of the inventive system and method, EAP may be one particular way for service providers to avoid network fraud and attacks.

According to the exemplary system and method described, a UCS 130, such as, for example, an FPS Server, may act as a session control for each user using free internet at the service provider network and will redirect the free internet users to FPS Server. When application reconvenes a data connection with the service provider, with attendant advertisement requests from AdS 140/145, an exemplary FPS Server 130 may monitor if end user using the internet service is not trying circumvent system advertisement protocols.

In another aspect, any change by an end user to avoid advertisements while obtaining service benefits will be met with various controls of an exemplary UCS/FPS 130. For example, as FPS Server 130 controls the session and will expect an advertisement request at some point in time. After a certain amount of time elapses, such as for example, an amount of time in which an ad should be sent to a user based on the type of data connection selected and provided, the server 130 will immediately request advertisements from AdS 140/145. When the time for displaying an advertisement approaches, an Ad may be sent to the user device 101 as a full web browser screen. After some predetermined time period, the user device 101 may resume web browsing for the user. A server 130 may request whether an advertisement has taken place as scheduled based on data stored on the user device (such as control data described above), or by a signal from the AdS 140/145. In an exemplary embodiment, the failure to receive a return signal marking the completion of an advertisement may alert FPS 130 that a user may try to bypass the advertisement protocols.

Alternatively, when a new session may be redirected to the UCS/FPS 130 Server, it means end users may not be using the application as it should, or is using WiFi directly through a WiFi portal or has a mobile device that cannot download Apps but have 2G, 3G connections. Where appropriate, these user connections may be redirected to UCS/FPS Server 130 via Service Provider Network 102.

According to the above exemplary situations involving an FPS/UCS 130 server, in response to irregular use of Mobile App/PC client, an exemplary UCS/FPS 130 may commandeer the end user's session. In this way, UCS/FPS 130 may control the end user application in regard to the Web AdS 140/145 perspective and request and deliver advertisements. In this exemplary scenario the only way to display Ads to the end user is using the web browser window. An exemplary FPS Server 130 may restrict all data traffic to web browsing, such as, for example, browsing of only URL (UDP/TCP port 80).

In embodiments where a user connects using the application or tries to reproduce the exact behavior of the PC/mobile application to get rid of Ads during the session, the session connection flow starts from user device 101 and hits the GGSN/S-GW 121/122 or the WiFi portal 123. In all cases if the FPS Server 130 is present in the Service Provider 102 architecture, the GGSN/S-GW/WiFi portal will redirect traffic to FPS Server 130.

The FPS server 130 may be able to detect when a new connection was establish and if the user application is being used; detect when a connection is undergoing and under what conditions (user application activated/inactived). In an exemplary scenario where user application is inactive, an exemplary FPS Server 130 may restrict all data traffic to web browsing, such as, for example, only browse URL (UDP/TCP port 80). Based on the service provider connection type used, an exemplary UCS 130 may also determine the interval advertisements should be displayed on the user device 101.

Additionally, when a new session may be detected, and a user application is inactive, FPS Server 130 may retrieve IP packets from a user's device 101, the user's IP protocol, and lookup in a database, such as an HSS database, to retrieve at least user MSISDN, being able to forward it to AdS 140 to get new advertisements from ad database 145 to fulfill database report.

In the exemplary embodiments where the system and method allow for inspection of IP packets to determine a user's MSISDN, FPS Server 130 may also look for user device 101 information like OS type and language, web browser/device/connection type and other possible info available to request the most suitable advertisement for this current user.

An exemplary FPS Server 130 may keep a record locally, such as may be the case in exemplary methods and systems where UCS/FPS 130 operates as a redundancy of AdS 140 and advertisement database 145. In this exemplary embodiment, a UCS/FPS 130 may maintain local records of how many connections per day, how many connections per MSISDN, and other such information that may be accessed and retrieved using FPS Admin GUI.

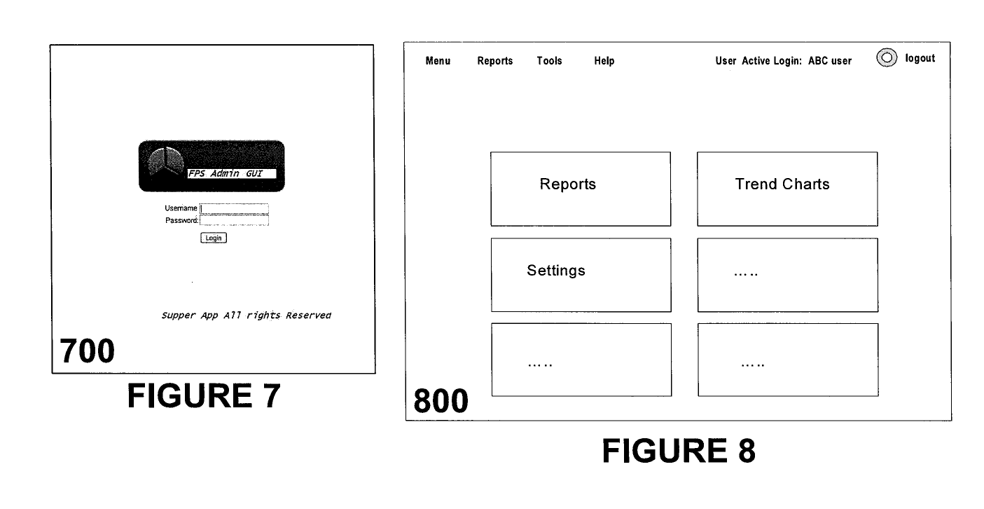

Referring to FIG. 7, an exemplary UCS/FPS 130 graphical user interface 700 may be accessible for sponsors and advertisers of user internet sessions. For example, an administrative graphical user interface may provide access to reports, trend charts, and settings, such as those depicted in user interface 800 in FIG. 8. In a preferred embodiment, each administrative user may obtain information from databases filtered and outputted for data analysis as user preferences. In one aspect, templates may be stored in a way to refresh report when needed. Exemplary trend Charts may include information from database filtered and outputted as charts. Exemplary setting preferences may also be customized and provided via menus to the administrative user.

In another exemplary embodiment of the system and method described, a UCS/FPS 103 may further enlist a user interface that allows for control of user sessions at the service provider level. In this way, an exemplary FPS Server 130 may manage a database, storing sessions info and only authorize user access if certain conditions are met.

In a preferred embodiment, database fields may include the following non-exhaustive list of data entries which may be found in UCS/FPS 130:

| | |
|---|---|
| Main table key | user ID(IMSI + MSISDN) |
| Service provider IP source | User device service provider IP |
| User language | Language of the user |
| Browser type | Browser type |
| OS type | OS type |
| Screen resolution | Screen resolution |

Similar to a UCS/FPS 130 administrative graphical user-interface 700 and settings window 800, an AdS administrative graphical user-interface 500 may be illustrated in an exemplary figure of a system and method described. FIG. 6 provides an illustrative embodiment of an exemplary web AdS administrative graphical user interface 600 for user applications and work in a “n” client-server mode. In an exemplary system and method, web AdS 140 may control and register all Ads demanded from “n” clients applications and send Ads to application client devices 101 from an internal or external advertisement database 145. Exemplary external Advertisement databases may include Grey strips, Mojiva, Google, or Facebook.

For internet service sponsors or advertisers, report and control features may be important. In an exemplary system, the AdS 140 may have a username and password for each advertiser and will record relevant usage info, which may or may not be authorized information from a user, and will manage an internal or external database 145 to control advertisement results. To access all this information/reports AdS 140 will have an administrative graphical user-interface 500/600.

An exemplary web AdS administrative graphical user-interface 600, as shown in FIG. 6, may contain both high level and detailed information. Similar to a UCS/FPS administrative graphical user interface 700/800, web AdS 600 may have links to Reports, Trend Charts, Settings, and advertisement Statistics. In a preferred embodiment, each user may be able to set up the desired screen options display, customizing for its best preference.

Exemplary reports may contain information from advertisement database 145 and may be filtered and outputted for data analysis as a web AdS interface 600 user prefers. In a preferred embodiment, templates may be stored in a way to refresh a database report when needed.

Exemplary trend charts may contain information from advertisement database 145 and may be filtered and outputted as charts. A user may set profile preferences and main screen options and menus like reports, trend charts and any other direct link as may be needed, such as a menu “Daily Report”.

Exemplary advertisement Statistics may include the number of advertisements sent per a period over AdS 140, the number of Ads per specific Advertiser, or the number of Ads per Advertiser to a specific MSIDSN. In an exemplary embodiment, monitoring of Ads transmission to a particular user or specific MSIDSN may allow advertisers to specifically target certain Ads to the user the next time the user logs onto the system. In an additional exemplary embodiment, the user's service experience (bandwidth, speed, breadth of internet experience/search, download capabilities) may be modified or based on the Ads the user receives or the administrative statistics show to be most successful in eliciting sales action from the user.

In an exemplary embodiment, administrative graphical user interface 600 for an AdS 140 may include financial statistics which may allow for control of advertisement amount displayed and/or include the daily or monthly balance due for telecom or service operator(s) and advertiser(s).

In a preferred embodiment, AdS database fields may include the following non-exhaustive list of data entries:

| | |
|---|---|
| Main table key | user ID(IMSI + MSISDN) + Serial |
| | number |
| advertisement | A number or advertisement |
| identification | description |
| Advertiser ID | A number or Advertiser |
| | description |
| Service provider source | Identification of service |
| | provider network source |
| User language | Language of the user |
| Ad result | If Ad was “clicked” by user: |
| | 2, only watched: 1 |

An exemplary administrative graphical user interface 600 may serve as a relevant source of user knowledge and interest and helps web AdS 140 to request the most suitable or cost-effective advertisement based on available/authorized user or user device 101 information.

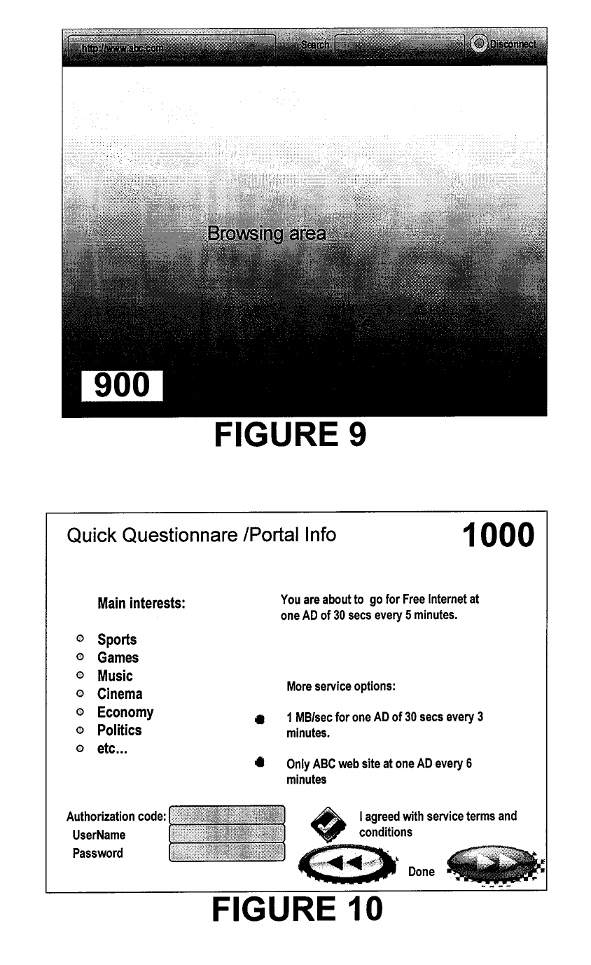

With reference to FIG. 9, once a user device 101 is connected to the system 100, it may see a browsing screen 900. Browsing screen 900 may open as a result of an application on user device 101 configured to operate in accordance with the present system and method. In this embodiment, the application can behave as a browser opening its own program window with a web page search option. Additionally, the exemplary application can be a video and audio player with capabilities, such as streaming any data from internet. Depending on the service provider used to connect to the internet, the exemplary application may restrict web browsing use to only browse certain site(s). In a preferred embodiment in which an application is used with the system and method described, the user may be restricted to only the application browsing window such as the type illustratively embodied in FIG. 9. Alternatively, the exemplary method and system described may just as easily function via a standard web browser 950 (not shown), such as those found through Internet Explorer and Firefox.

In an exemplary embodiment, when the application determines after some time (for example, some number of seconds/minutes) that it is time for an advertisement from AdS 140 to be communicated to user device 101, it will display an advertisement according to advertisement instructions stored on AdS database 145 or entered through user interface 800, such as, for example, advertisement displays over a user's full browsing area, display of advertisements as a vertical bar, banner or video, a sound, etc. In an exemplary embodiment, the interval between advertisement displays may depend on the service provider, its connection type, for example speed, brief questionnaire/portal information provided by user.

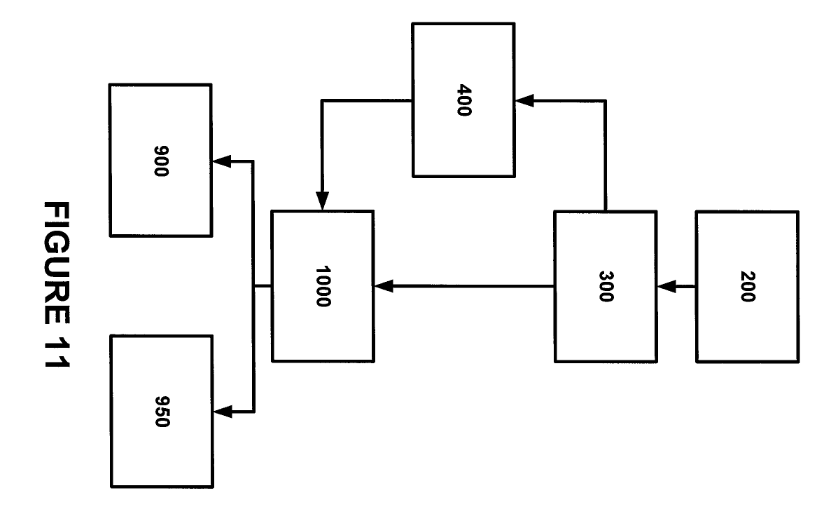

FIG. 10 illustrates an exemplary user questionnaire/portal information data collection screen 1000. In information collection screen 1000, a user's preferences may be entered, stored and later-used by the system and method to more efficiently target the service to provide a user, the advertisements to be sent to the user, and other information to control or modify a user's experience with using the system and method. For example, a user may be allowed to access a higher-level connection available only to a few users but with a special internet service provision such as connection speed or data transfer capabilities. According to one aspect of the exemplary system and method, UCS/FPS 130 may control whether a user may access the service desired based on the user's information obtained via information collection screen 1000. Alternatively, an advertiser or service provider sponsor may vet a user based on information collected through the system and method.

For example, a user may wish to establish a VIP connection to take advantage of the best service through a certain provider. In one scenario, the user may not be a desired user for the particular service because the user device 101 may be incompatible with the type of data connection necessary to provide the VIP connection. Alternatively, the user's information does not make the user a prime candidate for advertisements for any of the advertisers or sponsors of the VIP connection, and so the user may be denied access. According to this and other examples, UCS/FPS 130 or AdS 140 may independently or collectively manage user access to internet 125.

According to an exemplary system and method described, the administrative graphical user interface 600 may vary for the same user, or may not present itself if the interface has been accessed many times. In an exemplary embodiment, user interface 600 may be a sponsored portal. In a preferred embodiment where user interface 600 is a sponsored portal, the portal will ask user name, ask to select one or more topics of interest, offer differentiated speed/data access, and, in exchange for faster connections, deliver more Ads to the user device 101.

FIG. 11 illustrates an exemplary method of screen display on a user device 101 when operating according to the method described. As illustrated, main screen 200 may be the first screen a user sees when attempting to access the exemplary system described. A user may proceed to service selection screen 300 to select the type of service desired. At that point, new users may be directed to a registration screen 400 which will ultimately allow the user to access an information collection screen 1000. In an exemplary registration step, a service provider may opt to offer user registration via SMS, in which the user may send an SMS to a specific code and then receive a SMS response with an authorization code. Based on the service selected and the information provided, a user may obtain access to an internet service based on their agreement to accept advertisements throughout the internet connection via browsing screen 900 or the user's own standard browser 950.

During the process between information collection screen 1000 and service provision to a user device 101, the request PDP may be established, and the application will send a “hello” message to the UCS/FPS Server 130 (if the server is requested from service provider) and/or AdS 140 so all systems may be updated and ready to deliver/receive advertisements.

Where the connection sought from the user is an LTE/4G connection, instead of PDP context, a connection under an LTE/4G scenario may involve the system managing the so called default EPS Bearer and eventually dedicated EPS Bearer (if a specific QoS information must be sent).

Where the connection selected by the user (for example in FIG. 3) is WiFi, the WiFi network will be scanned for availability of connection, a portal may be authenticated, such as, for example, in authentication procedures with Cisco ISG or CSG/SSG, with data like IMSI/MSISDN as username/password and any other data combination. In a preferred embodiment, the system may require an authorization code be entered, such as, for example, a code previously agreed with the WiFi service provider. After a successful WiFi authentication, the user device 101 will be given an IP address and allow navigation of the internet.

In an exemplary embodiment, the service provider WiFi portal authentication may be done using parameters previously requested to the user during registration, such as at screen 400. When a WiFi connection is available, an exemplary application operating in accordance with the system and method described will send a “hello” message to UCS/FPS Server 130 (if the server is requested from service provider) and AdS so all systems are up to date and ready to deliver/receive advertisements.

Upon disconnection from the internet service, a user under mobile IP channel mode may remove the active PDP context/EPS Bearer so that subsequent connections via the service will require recreating a PDP context or EPS Bearer. More specifically, after disconnecting from a service session, the PDP or EPS will be deleted so the quota=zero is no longer present. According to this disconnection embodiment, parameters like “Quota” are no longer present and the service provider may charge the user under its data plan or may refuse a data connection if the user has no data plan. In embodiments where the user disconnects under WiFi mode, the exemplary method and system will disconnect the user device 101 from the WiFi network. In a preferred embodiment, a disconnection action may send a “goodbye” message to UCS/FPS Server 130 (if the server is requested from service provider) and AdS 140 so all systems are up to date.

In the described system and method, reference is made to user devices 101 that may or may not operate with local software to manage the system and method. In an exemplary option, a customized application may be provided to allow a user to have a service selection menu, registration portal and questionnaire portal focused on the internet provider sponsor. In a preferred embodiment, a web channel TV perhaps may simulate the perception of a TV channel and may allow one or more users to watch content only from a particular sponsor of the service. In a preferred embodiment with reference to FIG. 11, in order for an application to be launched, a user must select the service desired, for example on service selection screen 300. Following registration and information collection, a user may be able to browse using a standard browser, but, if such an option is not permitted, may receive the required application to maintain the connection to the service, screens 900 or 950 as illustrated in FIG. 11. As previously discussed, prior to a browsing session, an exemplary system and method may display one or more advertisements on the user device 101.

When an advertisement is to be displayed in the near future to the user, a request arrives at the UCS/FPS Server 130 and AdS 140, such as, for example, when the amount of time before delivery of an advertisement to user device 101 has almost elapsed. An exemplary advertisement request may contain one or more of the following information to the extent available or provided by the user or stored in the system: user identification, which may include IMSI, MSISDN, or both; user preferences from an exemplary information collection screen 1000, localization information if available and authorized by user; OS language; Browser type; device 101 brand and version; screen resolution; type of connection; a serial number (generated by an exemplary application); and device IP address. According to one aspect of an exemplary system and method, UCS/FPS 130 may gather and generate as much of the information from the user and/or user device 101 to populate parameters for AdS database 145.

Based on the received info the server will either search in its database for an appropriate advertisement or send this information via API to an external AdS database 145 for a “new” advertisement. This “new” advertisement may be delivered to the application, and, at the designated time, may interrupt the user data connection and display the advertisement. An advertisement may have special instructions for display on the user device 101 such as, for example, “full screen advertisement”, “upper bar advertisement,” “play video or sound.”

While the system and method have been described by way of example embodiments, it is understood that the words which have been used herein are words of description, rather than words of limitation. Changes may be made, within the purview of the appended claims without departing from the scope and spirit of the system and method in their broader aspects. Although the system and method have been described herein with reference to particular interrelated structures, interrelated materials, and interrelated embodiments, it is understood that the system and method is not limited to the particulars disclosed.

I claim:

1. A session control method, comprising the steps of:
connecting a first user device to at least one machine via a gateway;
monitoring a first connection between the first user device and the at least one machine;
monitoring a second connection between a second user device and the at least one machine;
correlating an advertisement in an advertisement server to the first user device based on the first connection;
disconnecting the first user device from the at least one machine for an interval;
presenting the advertisement on the first user device via the gateway during the interval;
disconnecting the second user device from the at least one machine during the interval; and
reconnecting the first user device to the at least one machine via the gateway after the interval.

2. The session control method of claim 1, further comprising the step of storing control data on the first user device that correlates to the advertisement.

3. The session control method of claim 1, further comprising the step of storing control data on the advertisement server.

4. The session control method of claim 2, wherein the control data includes a temporary internet file.

5. The session control method of claim 1, wherein the delivering of the advertisement to the first user device includes is based on instructions stored on a server connected to the at least one machine.

6. The session control method of claim 5, wherein the server is the advertisement server.

7. The session control method of claim 1, wherein the step of monitoring the first connection includes reading control data stored on the first user device.

8. The session control method of claim 1, wherein the step of monitoring the first connection includes reading control data stored on the advertisement server.

9. The session control method of claim 8, wherein the control data includes a temporary internet file.

10. The session control method of claim 1, wherein the step of monitoring the second connection takes place before the step of monitoring the first connection.

11. The session control method of claim 1, wherein the step of monitoring the first connection includes use of a PDP protocol.

12. The session control method of claim 11, further comprising the step of terminating the connection to the advertisement server after disconnecting the first user device.

13. The session control method of claim 1, further comprising the step of delivering a non-interactive communication to the first user device to allow for the connection between the first user device and the at least one machine via the gateway.

14. The session control method of claim 13, wherein the non-interactive communication delivered to the first user device is an SMS text.

15. The session control method of claim 13, wherein the non-interactive communication delivered to the first user device is a voicemail.

16. The session control method of claim 1, wherein the step of delivering the advertisement to the first user device via the gateway is preceded by a signal being sent to the first user device from the advertisement server.

17. The session control method of claim 16, further wherein the step of delivering the advertisement to the first user device via the gateway is preceded by a signal being sent to the first user device from the advertisement server and no response signal is received by the advertisement server from the first user device.

18. The session control method of claim 1, further comprising the step of restricting the reconnection between the first user device and the at least one machine to only one of a plurality of uses for the at least one machine.

19. The session control method of claim 18, wherein the one of the plurality of uses for the at least one machine is web browsing.

20. The session control method of claim 1, wherein the step of correlating the advertisement includes retrieving IP packets from the first user device and analyzing user-stored data from the first user device.
